(19) United States
(12) Patent Application Publication
(10) Pub. No.: US 2019/0384049 A1
(43) Pub. Date: Dec. 19, 2019

(54) IMAGE CONVERSION MODULE FOR A MICROSCOPE AND MICROSCOPE

(71) Applicant: CARL ZEISS MICROSCOPY GMBH, Jena (DE)

(72) Inventors: Alexander GAIDUK, Jena (DE); Thomas SERFLING, Jena (DE); Johannes WINTEROT, Jena (DE); Volker PUSCH, Hüttlingen (DE); Dominik STEHR, Jena (DE); Axel LASCHKE, Waake (DE); Tobias KAUFHOLD, Jena (DE); Stephan RICHTER, Jena (DE); Thomas MILDE, Nausnitz (DE)

(21) Appl. No.: 16/478,904

(22) PCT Filed: Jan. 15, 2018
(86) PCT No.: PCT/EP2018/050810

§ 371 Date: Jul. 18, 2019

(30) Foreign Application Priority Data
Jan. 18, 2017 (DE) 10 2017 100 904.3

(51) Int. Cl. G02B 21/36; G02B 26/08; G02B 27/00

(52) U.S. Cl. CPC G02B 21/361; G02B 26/0833; G02B 27/0075; G02B 21/362; G02B 21/365

(57) ABSTRACT

The present invention relates to an image conversion module for a microscope, the image conversion module being designed to convert images using an additional function. Said image conversion module initially comprises at least one functional element for implementing the additional function which is used for recording an extended depth of focus, for producing an optical zoom, for measuring spectral properties, the measuring color, for measuring polarization, for measuring wave fronts for measuring material properties and/or for aberration correction. Other components of the image conversion module are at least one image sensor, an optical interface which can be optically coupled to a lens of the microscope, a data interface for transmitting the data provided by the image sensor, and a mechanical interface for mechanically placing the image conversion module on the microscope. The invention also relates to a microscope comprising said type of image conversion module.

### BACKGROUND OF THE INVENTION

The present invention relates to an image conversion module for a microscope, which serves for image conversion and is configured with an additional function. The invention furthermore relates to a microscope for examining a sample, comprising such an image conversion module.

Microscopic applications frequently require imaging with an extended depth of field (EDoF). EDoF functionality generally also allows 3D model reconstruction. Known EDoF methods are based on what is known as focus variation and contrast evaluation by way of software. Focus variation is typically implemented by way of an actuator, with the result that a sample can be scanned in the direction of the optical axis. The components required for the EDoF functionality until now have been mostly structural and inseparable parts of microscopes.

DE 197 33 193 A1 discloses a microscope with adaptive optics. In this microscope, a transmitting wavefront modulator is arranged between an objective and a tube lens. The microscope can be used for confocal microscopy, for laser-assisted microscopy, for conventional microscopy or for analytical microscopy.

DE 10 2012 017 917 A1 describes a microscope module for being inserted in a beam path of a light microscope, having a module input for letting in a light beam, a module output for letting out a light beam, and an optics carrier on which various optical assemblies are arranged. An adjustable deflection device serves for selectively deflecting a light beam coming from the module input onto one of the optical assemblies and for deflecting a light beam coming from said optical assembly to the module output.

US 2016/0327779 A1 discloses an optical imaging device, comprising a beam splitter, a first and a second light scanning element, an objective, an illumination source for emitting illumination light into the objective via a first optical path that comprises the beam splitter and the first light scanning element. The beam splitter and the first light scanning element deflect the illumination light to a peripheral region of the objective such that the illumination light passes through the objective and forms an oblique imaging plane in a tissue. The objective guides light that is transmitted back by the oblique imaging plane to a second optical path containing the beam splitter and the second light scanning element. The beam splitter and a second light scanning element guide the light that has been transmitted back along the second optical path so as to form a stationary tilted intermediate image plane. A light detector captures an image of the intermediate image plane.

U.S. Pat. No. 7,345,816 B2 discloses an optical microscope which comprises a mirror with a controllably changeable continuous reflective surface. By changing the surface of the mirror, it is possible to record images from different focal positions, i.e. from different focal planes.

U.S. Pat. No. 7,269,344 B2 discloses an optical apparatus, comprising an optical system having a reflective variable optical element, an actuating circuit for actuating the optical element, and an image sensor. A computer unit is connected to the actuating circuit. An image processor is connected to the computer unit. The image processor is equipped with an electronic zoom function. The computer unit calculates a control signal for controlling the beam deflection function of the optical element on the basis of the data of the image sensor and of the electronic zoom data. The optical element is preferably configured in the form of a deformable continuous mirror having a reflective surface on a multilayer deformable structure. The multilayer structure comprises an electrode layer and is arranged on the upper side of a substrate. Electrodes are located on the lower side of the substrate. The electrodes and the electrode layer are connected to the actuating circuit. Different deformations of the deformable structure and of the reflective surface occur in dependence on the voltage applied.

The commercially available product “3D WiseScope microscope” from SD Optics Inc. permits fast generation of macroscopic and microscopic images, which have an extended depth of field. The product comprises, inter alia, an LED ring illumination, a coaxial illumination, a transmitted light illumination, a translation stage, objectives with 5×, 10×, 20× and 50× magnification and manual focusing. The focusing can be modified with a frequency of 1 to 10 kHz and more. A mirror array lens system, referred to as a MALS module, serves to implement the EDoF functionality. MALS denotes a mirror array lens system. Details of this system are disclosed, for example, in WO 2005/119331 A1 or WO 2007/134264 A2.

For fast modulation of the refractive index of a liquid reservoir, the product “TAG Optics lens module” from TAG Optics is known, which equips microscopes with EDoF functionality. The product uses sound waves for controlling lenses.

The company Mejiro Genossen Inc. offers an optical microscope which is based on the tilted optical Offner mirror system and is operated in Scheimpflug arrangement. The microscope permits significant improvement of the depth of field over a large field of view. The focusing abilities of this microscope, however, are difficult to control. In addition, specific imaging errors must be corrected.

Furthermore, the company frinGOe has developed a compact passive spectrometer, which combines a Mach-Zehnder interferometer, CMOS imaging processing and FTIR spectroscopy.

The Fraunhofer-Institut für Integrierte Schaltungen has developed a polarization camera, which is called POLKA. The POLKA captures and measures the polarization state of light in real time. The core of the camera is a nanostructured CMOS sensor, in which the polarization filters are anchored directly in the individual pixels. It is thus possible to capture and measure linearly polarized light pixel by pixel with a single recording. The pixel-based polarization filters are aligned in 4 different directions (0°, 45°, 90°, 135°), as a result of which light waves of different polarization can be captured at the same time. Movement artifacts are avoided by way of special processing of the pixel signals. The recorded images can be transmitted to a PC. Visualization algorithms make it possible to render intensity, angle and degree of polarization visible to the human eye.

Finally, solutions for optical wavefront coding are known, which use a phase mask in an objective of a microscope for quick EDoF imaging.

### SUMMARY OF THE INVENTION

The object of the present invention is the provision of an image conversion module for a microscope serving to equip the microscope with additional functionality for image conversion. The image conversion module is intended to be able to be used with little outlay and in a task-specific manner in different microscopes. Furthermore, a microscope having an image conversion module of this type is intended to be provided.

The object according to the invention is achieved by way of an image conversion module for a microscope as claimed in claim 1, and a microscope as claimed in the attached coordinate claim 10.

The image conversion module according to the invention is configured with an additional function for image conversion. The image conversion module comprises to this end at least one functional element for implementing the additional function, serving for recording an extended depth of field, for implementing an optical zoom, for measuring spectral properties, for colorimetry, for polarization measurement, for wavefront measurement for measuring material properties and/or for aberration correction. A further component of the image conversion module is at least one image sensor. An optical interface of the image conversion module serves for optically coupling the image conversion module to an objective of the microscope. The image conversion module is equipped with a data interface for transmitting the data output by the image sensor. A mechanical interface serves for releasably attaching the image conversion module to the microscope, with the result that it is able to be attached to the microscope and to be removed from it, as needed.

A substantial advantage of the image conversion module according to the invention is that it is possible thereby to equip a microscope with additional imaging functionality in a simple manner. According to the invention, the components required for implementing the additional function are in particular combined with the image sensor to form an independent structural unit. A mechanical standard interface, which is already present on the microscope and serves for connecting photo and video cameras, can be used to connect the image conversion module to the microscope. In the interface, the distance and the size of an intermediate image generated by way of the microscope and of a pupil of the interface determine the connection conditions for the image conversion module. The image conversion module can be removed without difficulty from the microscope and be replaced, for example, by an image conversion module of different configuration having a different additional function. For different applications, it is thus possible to keep image conversion modules having different functional elements for implementing different additional functions, which can then be attached to the microscope as required. The microscope can therefore be adapted to the respective requirement with little outlay. The image conversion module can comprise a plurality of functional elements for providing a plurality of additional functions.

According to a particularly preferred embodiment, the at least one functional element is an active optical element. An active optical element within the context of the invention is an optical element which actively changes the properties of the optical beam path. The optically active element is preferably selected from the following list: an optical actuator, a liquid lens, a lens that is preferably controllable by mechanical oscillations, preferably by sound waves, an interferometer array, preferably a passive interferometer array, a Fabry-Perot element, for example an actively controlled Fabry-Perot element, a phase mask, a polarization mask, a spatial light modulator. The image conversion module can preferably have a plurality of active optical elements of various types.

An advantageous embodiment of the image conversion module uses an optical actuator, which is configured as a microsystem with mechanically movable micromirrors for recording an extended depth of field. In this embodiment, use can be made, for example, of the above-described “MALS module” by SD Optics Inc. as an optical actuator. By way of example, a MALS module may be configured as a Fresnel lens, as described, for example, in WO 2005/119331 A1. This Fresnel lens is formed by a multiplicity of micromirrors. The focal length of the Fresnel lens can be changed very quickly by changing the position of the micromirrors. This quick change in the focal length permits very quick setting of the focal plane to be imaged. This renders it possible to record a multiplicity of recordings in adjacent focal planes in a short period of time. Such a sequence of images which were recorded in different focal planes is also referred to as a focus stack. An image with an extended depth of field can be ascertained from a focus stack.

According to a further developed embodiment, a beam splitter is arranged between the optical interface and the microsystem.

It has proven advantageous for the image conversion module to be equipped with a mirror system. The mirror system comprises a concave mirror and a convex mirror that is arranged opposite the concave mirror. The convex mirror is configured as an optically active element. The concave mirror and the convex mirror are preferably oriented perpendicularly to an image plane. Alternatively, the concave mirror and the convex mirror can also be oriented parallel to the image plane.

According to a preferred embodiment, the mirror system furthermore comprises a first plane mirror, which is arranged between the optical interface and the concave mirror and is oriented at an angle with respect to the image plane for deflecting beams in the direction of the concave mirror. The beams that are incident on the first plane mirror are preferably deflected by 90°. A second plane mirror which is oriented at an angle with respect to the image plane for deflecting beams in the direction of the image sensor is arranged between the concave mirror and the image sensor. The beams that are incident on the second plane mirror are preferably deflected by 90°. By varying the convex mirror, which is configured as an optically active element, the focuses, i.e. the focal planes, are displaced along the chief rays and image different object depths on the image sensor. The imaging errors thus caused by the microscope are compensated for by adapted deformation of the optically active element. If the profile of the chief ray in the object space deviates from telecentry, the object is imaged on the sensor with a varying imaging scale. This embodiment of the image conversion module can, in addition to its use as an image conversion module, also be used as an independent microscope.

According to an advantageous embodiment, further functional elements, for example for implementing spectral measurements or colorimetry, can be integrated in the mirror system.

For implementing material property measurements, such as for example temperature measurement, for capturing elastic properties and the like, the functional elements preferably comprise the sensor elements required for the respective measurement.

According to a preferred embodiment, the functional elements include at least one mechanical actuator, which preferably serves for displacing an optical component.

According to an advantageous embodiment, the image conversion module includes at least one electronic control unit for controlling the functional elements and the image sensor. The control unit is adapted to the respectively used functional elements and to the respectively used optical elements.

It has proven advantageous for the image conversion module to be equipped with an internal data processing unit for processing the data captured by the image sensor. Alternatively or additionally, the image conversion module can also include an interface for transmitting the data captured by the image sensor or the data processed by the internal data processing unit to an external data processing unit.

The image conversion module advantageously has an energy supply unit or, alternatively, an electric interface for supplying the image conversion module with power from an external source.

The microscope according to the invention first comprises an objective for optical imaging of a sample in an image plane. By means of the objective, an image is representable in the image plane with an optical resolution. The optical resolution is determined by the physical processes and the properties of the objective. The microscope furthermore comprises the image conversion module explained, which is optically coupled to the objective by way of its optical interface. The image conversion module is furthermore mechanically connected to the microscope by way of its mechanical interface.

The microscope preferably has microscope illumination for illuminating the sample that is to be examined under the microscope. The microscope illumination preferably comprises transmitted light illumination, ring illumination and coaxial illumination, which, alternatively or together, can be used to illuminate the sample.

### BRIEF DESCRIPTION OF THE DRAWINGS

Further details and developments of the invention will become apparent from the following description of preferred embodiments, with reference being made to the drawing. In the figures:

FIG. 1 shows a schematic illustration of a microscope according to the invention;

FIG. 2 shows a first preferred embodiment of an image conversion module according to the invention for recording an extended depth of field;

FIG. 3 shows a mirror system of the image conversion module;

FIG. 4 shows a second preferred embodiment of the image conversion module for recording an extended depth of field;

FIG. 5 shows a third preferred embodiment of the image conversion module for spectral measurements.

### DETAILED DESCRIPTION OF THE INVENTION

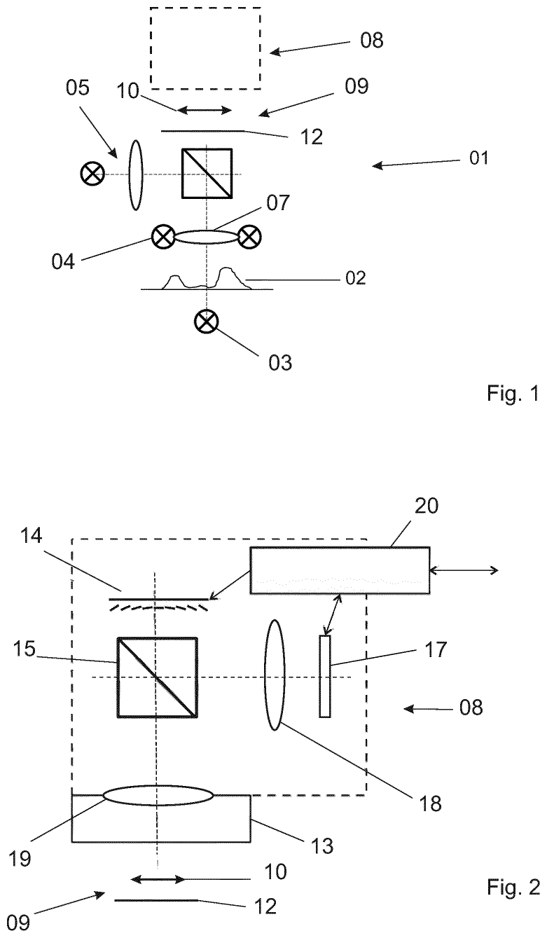

FIG. 1 shows a schematic illustration of a microscope 01 according to the invention. A sample 02 can be examined using the microscope 01. The microscope 01 comprises transmitted light illumination 03, ring illumination 04 and coaxial illumination 05, which, alternatively or together, serve to illuminate the sample 02. The microscope 01 furthermore includes an objective 07 and an image conversion module 08, which is optically coupled to the objective 07 by way of an optical interface 09. In the optical interface 09, the distance and the size of an intermediate image 10 generated by way of the microscope 01 and of a pupil 12 of the optical interface 09 determine the connection conditions for the image conversion module 08. The image conversion module 08 is configured for image conversion with one or more additional functions. Preferred embodiments of the image conversion module 08 will be explained in more detail below with reference to FIGS. 2 to 5.

FIG. 2 shows a first preferred embodiment of the image conversion module 08 for recording an extended depth of field. The image conversion module 08 comprises the optical interface 09 with the pupil 12, via which the image conversion module 08 is optically coupled to the objective 07 of the microscope 01. A mechanical interface 13 serves for mechanically attaching the image conversion module 08 to a housing (not illustrated) of the microscope 01.

The image conversion module 08 furthermore comprises a functional element 14 for implementing the additional function, which in the embodiment shown consists of recording an extended depth of field. For implementing this additional function, the functional element 14 is configured as a microsystem having movable micromirrors for measuring depth information of the sample 02. The microsystem having the movable micromirrors is arranged in a back-reflecting manner above a beam splitter 15. The functional element 14 is arranged conjugate to the pupil 12 of the optical interface 09.

An image sensor 17 is a further component of the image conversion module 08. The beam splitter 15 reflects the light reflected by the functional element 14 back to the image sensor 17. The image sensor 17 serves for converting an image that is imaged directly or indirectly on the image sensor 17 by the objective 07. By varying the functional element 14, the focuses are displaced along the chief rays and image different object depths on the image sensor 17. At the same time, the functional element 14 corrects aberrations in the image plane.

In addition, the functional element 14 can be used exclusively for correcting aberrations, without focusing. If the functional element 14 is not used for focusing, it can alternatively be used to correct changes in the scale of the imaging of non-telecentric optical units. If the profile of the chief ray in the object space deviates from telecentry, the object is imaged from different distances on the sensor with a varying imaging scale.

If desired, a tube lens 18 is arranged between the image sensor 17 and the beam splitter 15. In the embodiment shown, an optional image conversion module objective 19 is located between the optical interface 09 and the beam splitter 15.

The image conversion module 08 includes further components 20 for energy supply, for data processing and for control tasks. The further components 20 are illustrated combined as one unit in FIG. 2, but can consist of different, structurally separate units. Part of these further components 20 is an energy supply unit or alternatively an electric interface for supplying the image conversion module 08 with power. The energy supply unit can be implemented, for example, by way of batteries which are preferably chargeable. The further components 20 preferably include an internal data processing unit for processing the data captured by the image sensor 17. However, alternatively or additionally, the image conversion module 08 can also be equipped with an interface for transmitting the data captured by the image sensor 17 or the data processed by the data processing unit to an external data processing unit. The further components 20 preferably also comprise at least one electronic control unit for controlling the functional element 14 and the image sensor 17.

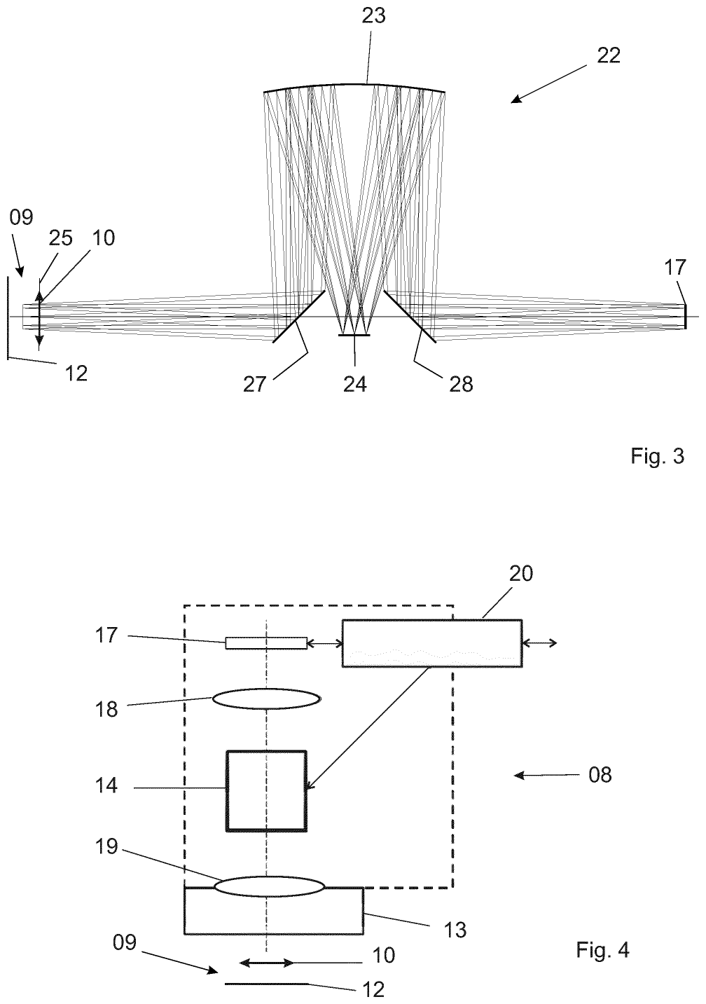

FIG. 3 shows a mirror system 22 of the image conversion module 08 with a plotted beam path. The mirror system 22 comprises a concave mirror 23 and a convex mirror 24 that is arranged opposite the concave mirror 23. The convex mirror 24 is configured in the form of an optically active element, which is preferably implemented as the microsystem having movable micromirrors. The convex mirror 24 is furthermore arranged conjugate to the pupil 12 of the optical interface 09. The construction deviates from the classical Offner system to create space for the real optically active element. The concave mirror 23 and the convex mirror 24 are oriented perpendicularly to an image plane 25. A first plane mirror 27 which is oriented at an angle with respect to the image plane 25 for deflecting beams in the direction of the concave mirror 23 is arranged between the optical interface 09 and the concave mirror 23. The beams that are incident on the first plane mirror 27 are deflected by 90° in the configuration shown. A second plane mirror 28 which is oriented at an angle with respect to the image plane 25 for deflecting beams in the direction of the image sensor 17 is arranged between the concave mirror 23 and the image sensor 17. The beams that are incident on the second plane mirror 28 are deflected by 90° in the configuration shown. By varying the convex mirror 24, the focuses, i.e. the focal planes to be imaged, are displaced along the chief rays and image different object depths on the image sensor 17. At the same time, the convex mirror 24 corrects aberrations in the image plane. The convex mirror 24 can likewise be used exclusively for correcting aberrations, without focusing. If alternatively the convex mirror 24 is not used for focusing, it can be used for correcting changes which occur in terms of scale of the imaging of non-telecentric optical units.

The embodiment of the image conversion module 08 shown in FIG. 3 can be used as an independent microscope. Further functional elements can be integrated in the mirror system 22. For example, functional elements, for spectral measurements or colorimetry, can be arranged in the mirror system 22 at suitable sites.

FIG. 4 shows a second preferred embodiment of the image conversion module 08 according to the invention for recording an extended depth of field. In contrast to the embodiment shown in FIG. 2, the functional element 14 here includes a lens that is controllable by mechanical oscillations, preferably by way of sound waves. The intermediate image 10 of the microscope 01 conjugates to the object plane of the image conversion module objective 19. The functional element 14 conjugates to the pupil 12 of the optical interface 09.

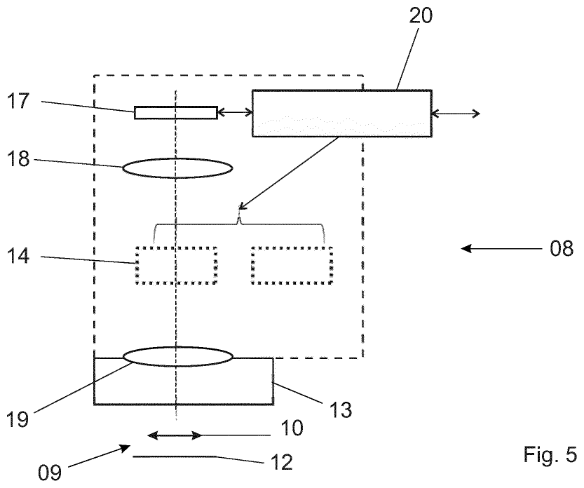

FIG. 5 shows a third preferred embodiment of the image conversion module 08 according to the invention for spectral measurements. The functional element 14 comprises an interferometer array. The passive spectrometer developed by the company fingGOe can be used as such, for example. The interferometer array can be inserted into and removed from the optical path such that the user can switch between the functions image recording and spectral measurements. A further possibility is the arrangement of further functional elements 14. For example, an active Fabry-Perot element for spectral measurements with high spatial resolution up to the individual pixel resolution can be used. For measurements with an extended depth of field, a phase mask or a spatial light modulator can be integrated in the arrangement. Likewise possible is the use of a polarization mask for polarization measurements with a high spatial resolution.

1. An image conversion module for a microscope, comprising the following components:
at least one image sensor;
at least one functional element for implementing one of the following additional functions,
taking recordings with an extended depth of field,
implementing an optical zoom,
measuring spectral properties,
colorimetry,
polarization measurement,
wavefront measurement for measuring material properties, and/or
correcting aberrations;
an optical interface, which is able to be optically coupled to an objective of the microscope;
a data interface for transmitting the data output by the image sensor; and
a mechanical interface for releasably attaching the image conversion module to the microscope.

2. The image conversion module as claimed in claim 1, wherein the at least one functional element is an active optical element selected from the following list:
an optical actuator,
a liquid lens,
a lens that is controllable by mechanical oscillations,
an interferometer array,
a Fabry-Perot element,
a phase mask,
a polarization mask,
a spatial light modulator.

3. The image conversion module as claimed in claim 2, wherein the optical actuator is configured as a microsystem with mechanically movable micromirrors for recording an extended depth of field.

4. The image conversion module as claimed in claim 1, wherein it comprises a mirror system having a concave mirror and a convex mirror which is arranged opposite the concave mirror and is configured as an optically active element.

5. The image conversion module as claimed in claim 4, wherein the mirror system furthermore comprises a first plane mirror, arranged between the optical interface and the concave mirror, and a second plane mirror, arranged between the concave mirror and the image sensor, wherein the first plane mirror is oriented at an angle with respect to the image plane for deflecting beams in the direction of the concave mirror, and wherein the second plane mirror is oriented at an angle with respect to the image plane for deflecting beams in the direction of the image sensor.

6. The image conversion module as claimed in claim 4, wherein the convex mirror is configured as the microsystem with the mechanically movable micromirrors.

7. The image conversion module as claimed in claim 4, wherein the first and the second plane mirrors are oriented such that beams that are incident on the plane mirrors are deflected by 90°.

8. The image conversion module as claimed in claim 1, wherein it includes an internal data processing unit for processing the data captured by the image sensor and/or an interface for transmitting the data captured by the image sensor and/or the data processed by the internal data processing unit to an external data processing unit.

9. The image conversion module as claimed in claim 1, wherein it has an energy supply unit or an electric interface for power supply.

10. A microscope having an objective and an image conversion module as claimed in claim 1, which is optically coupled to the objective.
